(19) United States
(12) Patent Application Publication
(10) Pub. No.: US 2002/0081478 A1
(43) Pub. Date: Jun. 27, 2002

(54) Bipolar plate

(76) Inventor: Ilona Busenbender, Rheinbreitbach (DE)

Correspondence Address: Cary W. Brooks, General Motors Corp. - Legal Staff, Mail Code 482-C23-B21, PO Box 300, Detroit, MI, 48265-3000, US

(21) Appl. No.: 10/004,322

(22) Filed: Oct. 25, 2001

(30) Foreign Application Priority Data
Nov. 24, 2000 (DE) 10058337.7

(51) Int. Cl. H01M 4/66; H01M 8/02

(52) U.S. Cl. 429/34; 429/210; 429/245; 429/44

(57) ABSTRACT

A sheet metal product, in particular for use as a bipolar plate in a fuel cell or in an electrolyzer, is characterized in that it has, on at least one side, a conductive and corrosion-resistant protective coating of a metal oxide having a treatment which ensures the conductivity. The coating can be produced in such a way that a piece of sheet metal is introduced into a coating plant and is provided there with the conductive and corrosion-resistant protective coating of the metal oxide.

### TECHNICAL FIELD

The present invention relates to a sheet metal product, in particular for use as a bipolar plate in a fuel cell or in an electrolyzer, to a plate of this kind and also to a method of manufacturing a sheet metal product and a bipolar plate.

### BACKGROUND OF THE INVENTION

So-called bipolar plates are used in all types of fuel cells and form both a closure impermeable to gas and liquids for a respective cell and also, with a stacked arrangement of cells, an electrical connection between adjacent cells, so that the positive side of the one cell is simultaneously the negative side of the adjacent cell, which is the reason for the name “bipolar plate”.

Problematic in such bipolar plates is the fact that they are subject to corrosion in the environment of the fuel cell, with corrosion producing substances being present in all types of fuel cells.

At the present time, such bipolar plates are provided with a corrosion-resistant layer of a noble metal, such as gold or platinum. Such layers of noble metals are admittedly corrosion-resistant and simultaneously provide the required conductivity. However, they are expensive.

Bipolar plates are also known which are manufactured from graphite and graphite/plastic mixtures, such as are described in EP-A-0933825. These are, however, brittle materials. In order to machine these material and to use them in a fuel cell, the plates must have a certain thickness, which is disadvantageous with respect to the power-to-weight ratio of a fuel cell stack and thus also has an effect on the use of fuel cells in mobile applications, for example, as a source of motive power for a vehicle. The use of plates of graphite and graphite/plastic mixtures is accordingly likewise associated with disadvantages.

### SUMMARY OF THE INVENTION

The object of the present invention is to provide a sheet metal product or a bipolar plate of the initially named kind which can be manufactured at favorable cost, but which nevertheless has the required conductivity and resistance to corrosion, and indeed without the product or the plate having a high weight or a significant space requirement or causing high manufacturing costs or material costs. Furthermore, the invention is concerned with the object of manufacturing such sheet metal products and plates.

In order to satisfy this object there is provided, in accordance with a first embodiment of the invention, a sheet metal product of the initially named kind which is characterized in that the sheet metal product has a conductive and corrosion-resistant protective coating of a metal oxide on at least one side, with the metal oxide having a treatment which ensures the conductivity.

Furthermore, the present invention relates to a bipolar plate which is formed from a sheet metal product and which has at least one side a conductive and corrosion-resistant protective coating of a metal oxide having a treatment which ensures the conductivity.

The invention is based on the consideration that very thin layers of metal oxides, which have an excellent resistance to corrosion, but which normally count as electrically insulating, can be made conductive by a suitable treatment, so that they can be used to provide a sheet metal product or a plate of metal which is, on the one hand, resistant to corrosion but, on the other hand, conductive, so that current can flow from one side of the plate into the plate and can flow from one side of the plate to the other side of the plate.

Thin conductive coatings of a metal oxide with a doping which ensures conductivity are known from the document EP-A-983973. There, this coating is applied to panes of glass in order to so influence the optical characteristics that a reflection of long-wave light takes place in order to achieve a thermally insulating effect, whereby the electrical conductivity is also simultaneously increased. The conductivity which arises is, however, merely a side effect there. There, the coating has no corrosion preventing action, since panes of glass are in any event resistant to corrosion. A product which has both a high conductivity on the one hand and excellent resistance to corrosion on the other hand first arises through the provision of a sheet metal product with a conductive and corrosion-resistant protective coating of metal oxide having a treatment which ensures the conductivity. A main use of such a sheet metal product is, as mentioned above, as a bipolar plate in a fuel cell. However, a series of other possible applications certainly also comes into consideration in which one requires conductive parts of a favorably priced metal with a corresponding corrosion-resistant coating, for example in the construction of transformers and in larger electrical substations.

At this point, reference should be made also to the document “From ZnO Colloids to Nanocrystalline Highly Conductive Films” in J. Electrochem. Soc., Vol. 145, No. 10, October 1998, pages 3632-3637 by M. Hilgendorf, L. Spanhebel, Ch. Rothenhäusler and G. Müiller. Here, chemical processes for the manufacture of conductive zinc oxide layers containing aluminum or indium for window electrodes for solar cells or electroluminescent components are described, with the coating not having to achieve any corrosion-preventing action, but likewise also being capable of being used for the purpose of the present invention.

The treatment of the metal oxide required by the invention to ensure conductivity can take various forms. One possibility is to produce a special crystal structure of the metal oxide coating, so that this adopts a conductive form. A further possibility is to apply a conductive coating comprising one of the elements aluminum, chromium, silver, antimony or molybdenum onto the sheet metal beneath the metal oxide coating. These elements form, together with the coating of the metal oxide applied thereon, a type of doping of the metal oxide which places the latter in a conductive state.

Another possibility is to provide the metal oxide coating with a simultaneously or subsequently deposited doping.

Such protective coatings have the advantage that they are carried out in one working step in a treatment chamber, whereby the sheet metal product can be made at a correspondingly favorable cost.

The protective coating can consist solely of one layer, that is to say it is not essential to deposit a plurality of different layers on the sheet metal part. In this way the coating process is simplified and the manufacturing costs are reduced.

The protective coating preferably consists of an oxide of tin, zinc or indium, or of an oxide of an alloy of these elements. It has been shown that such metal oxides have, on the one hand, an excellent resistance to corrosion and, on the other hand, can be made conductive through the use of dopants.

The protective coating preferably consists of a first layer of a metal oxide, of a second layer of a dopant, which ensures the conductivity, and of a third layer of metal oxide. It has been found that a three-layer coating of this kind leads to excellent resistance to corrosion and conductivity. If three layers are provided, then these can be deposited, for example by a PVD method, in a vacuum chamber, so that the manufacturing costs can be kept low. A further possibility of forming the protective coating lies in forming these from an alternating layer sequence of metal oxides and dopants which ensure the conductivity. For this purpose, PVD coating plants which are known per se can be used in which the articles to be coated, here sheet metal parts, are exposed on a rotating plate one after the other to the vapor flux of various coating sources, whereby an alternating layer sequence of this kind can be economically produced. A further possibility lies in producing the protective coating from at least two layers which consist of different metal oxides and are respectively doped, with the doping, for example, being carried out as so-called “volume doping”. In other words, the protective coating of the invention is not restricted to a protective coating of only one type of metal oxide.

The dopant, which ensures the conductivity, can for example consist of at least one element of the group aluminum, chromium, silver, boron, fluorine, antimony, chlorine, bromine, phosphorus, molybdenum and/or carbon.

The coating itself is preferably a coating deposited in a vacuum chamber, i.e. a coating which is deposited by a PVD process. A process of this kind makes it possible to deposit very thin layers uniformly at a favorable cost. For example, a protective coating of this kind can be deposited with a thickness in the range between 1 monolayer and one μm, preferably between 5 and 100 nm on a sheet metal part. Moreover, the use of such PVD processes brings the advantage that the sheet metal part can be cleaned at the start of the coating process by ion bombardment or plasma etching and that a good anchoring arises between the protective coating and the sheet metal part. It has surprisingly been found that very thin protective coatings are already sufficient in order to ensure the resistance to corrosion of the sheet metal product. When using a sheet metal product as a bipolar plate of a fuel cell, the plate is not actually exposed to any pronounced mechanical loading so that a very thin coating is already sufficient in order to ensure the required corrosion resistance and conductivity over a longer period of time, since a mechanical injury of the coating need not be feared. With very thin coatings, for example under 100 nm thickness, the metal atoms lying beneath it can also lead to a type of doping which ensures the conductivity of the coating, i.e. the application of a very thin layer onto a sheet metal part itself represents the treatment which leads to the conductivity of the metal oxide coating.

The sheet metal which is used for the formation of the sheet metal product or the bipolar plate preferably comprises one of the following materials: aluminum, chrome-plated aluminum, copper, stainless steel, chrome-plated stainless steel, titanium, titanium alloys and iron containing compounds both with and without metallic coating.

The sheet metal product itself can straightforwardly have a thickness in the range from about 0.001 mm to about 5 mm. It is thus sufficient to produce very thin sheet metal products or bipolar plates which, on the one hand, have the required impermeability for gases and fluids but, on the other hand, exhibit the required resistance to corrosion and conductivity, with such sheet metal product thicknesses additionally permitting the structuring of the sheet metal product. Further preferred embodiments of the invention can be found in the further patent claims and also in the subsequent description.

### BRIEF DESCRIPTION OF THE DRAWINGS

The invention will be explained in more detail in the following with reference to embodiments and to the drawings in which are shown:

FIG. 1 is a schematic plan view of a bipolar plate of a fuel cell with a protective coating in accordance with the invention;

FIG. 2 is a cross-section through the bipolar plate of FIG. 1 in accordance with the section plane II-II;

FIG. 3 is a cross-section through the bipolar plate of FIG. 1 corresponding to the section plate III-III;

FIG. 4 is a schematic cross-section of a section of two adjacent fuel cells in order to explain the use/function of the bipolar plates;

FIG. 5 is an enlarged representation of a region of the bipolar plate of FIG. 1 in order to show details of the protective coating of the invention;

FIG. 6 is a schematic view of a first plan for the production of a sheet metal product in accordance with the invention;

FIG. 7 is a schematic plan view of a strip of sheet metal which passes through progressive tooling in order to produce a bipolar plate in accordance with the invention;

FIG. 8 is a schematic representation of a coating chamber for the coating of sheet metal parts for the formation of bipolar plates in accordance with the invention; and

FIGS. 9A-9D show cross-sections similar to FIG. 5 in order to illustrate alternative coatings.

### DESCRIPTION OF THE PREFERRED EMBODIMENT

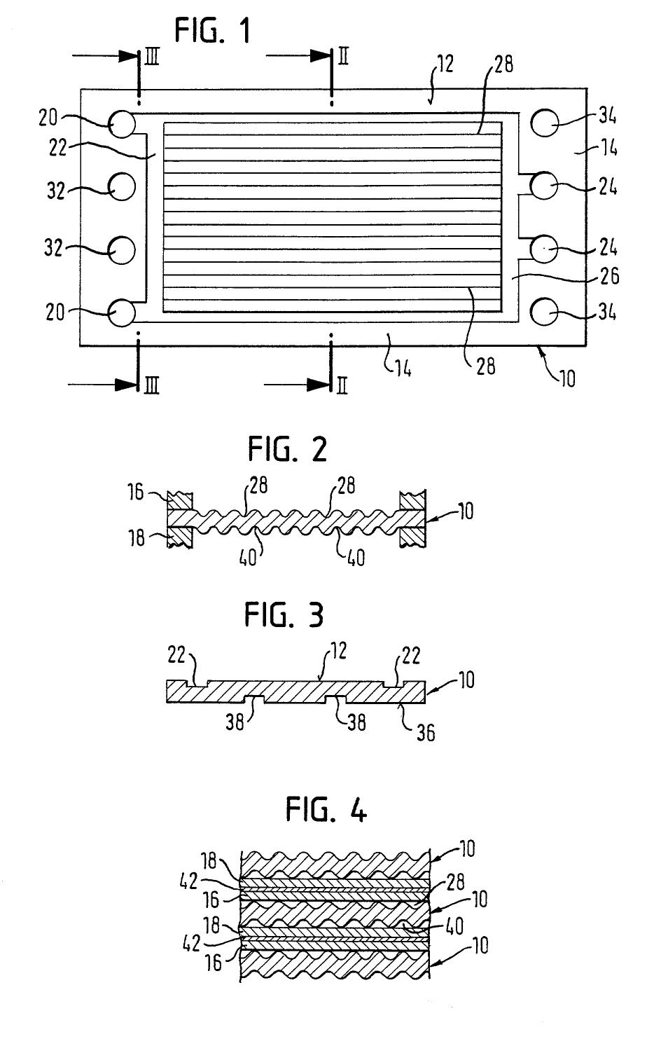

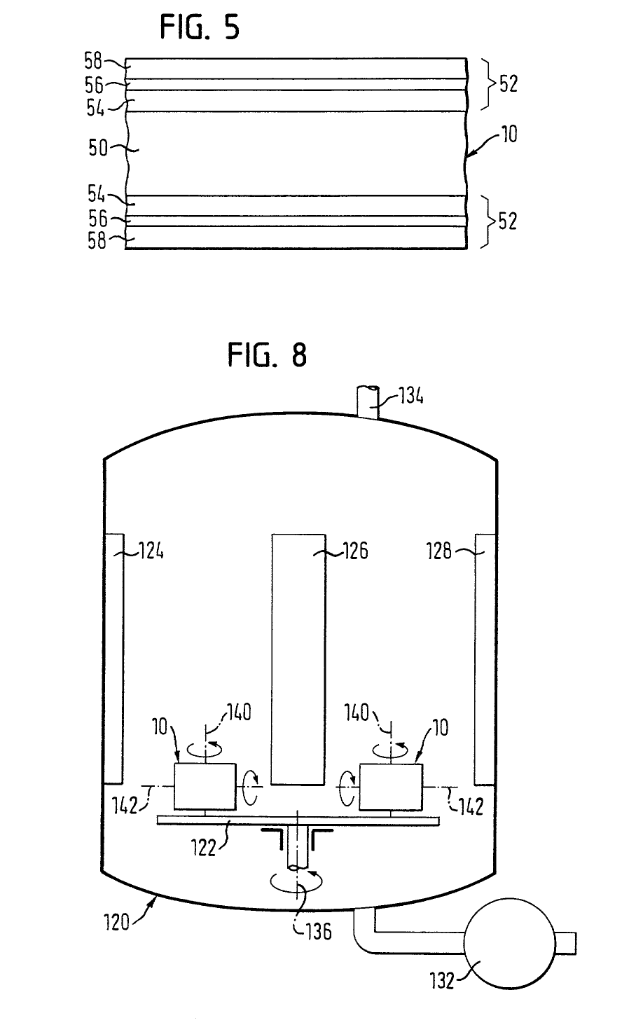

FIGS. 1 through 3 show first of all a bipolar plate 10 which is suitable for use in a fuel cell arrangement consisting of a plurality of stacked PEM fuel cells (as indicated in FIG. 4). Such bipolar plates are well known per se; they are, for example, described in the following documents: EP-A-97202343.6, EP-A-0975039, WO98/53514, EP-A-0940868, WO98/10477 and EP-A-0984081.

The present FIGS. 1 through 4 are simply schematic drawings in order to explain the shaping of such bipolar plates.

The upper side of the bipolar plate 10 of FIG. 1 is provided with a peripheral margin 14 which lies in a plane and which makes it possible to integrate the plate in a stack of plates and to ensure a sealed connection to upper and lower plates 16 and 18, which are only schematically shown in the FIGS. 2 and 3. At the one side of the plate two supply openings 20 for, for example, air are provided which communicate with a recessed channel region 22. At the other side of the bipolar plate there are two further discharge openings 24 for used air which communicate with a recessed channel region 26. Between the recessed channel region 22 and the recessed channel region 26 there are flow passages which extend in the longitudinal direction of the bipolar plate and which make it possible for air supplied via the supply openings 20 to flow from the left-hand side of the plate to the right-hand side of the plate to the discharge openings 24. During this, this air reaches catalytically-coated surfaces of the plate 16 belonging to the membrane electrode assembly (MEA) disposed above the channels 26 and reacts there with protons in order to form water, whereby an electrical current is produced which flows through the bipolar plate 10.

The further openings 32 and 34 of the plate represent supply and discharge openings for hydrogen. These openings are separated at the upper and lower sides 12 and 13 of the bipolar plate in FIG. 3 by regions of the plate lying in the plane of the frame 14 from the air supply and discharge openings 20 and 24 and from the correspondingly recessed regions 22 and 26 and are sealed relative to the latter and to the environment.

At the lower side 36 of the plate 10 there are provided recessed channel regions in accordance with FIG. 3, in an arrangement inverted relative to FIG. 1, i.e., the two supply openings 32 communicate with a recessed channel region 38 corresponding to the channel region 36 on the upper side of the plate 10, whereas the two discharge openings 34 communicate with a (non-illustrated) recessed channel region, which is formed in accordance with the channel regions 22. The channel regions at the lower side 36 of the plate 10 communicate with the longitudinal channels 40 formed in the lower side of the plate, so that hydrogen can flow from the supply openings 32 to the discharge openings 34.

As shown in FIG. 4, the lower side of the bipolar plate 10 belongs to the neighboring fuel cell and delivers protons to the membrane 42 of this cell, with the protons passing through the membrane and being reacted with atmospheric oxygen in the adjacent reaction chamber, whereby power is produced on the one hand and water is generated on the other hand. The air flow in the neighboring cell is made available by the lower bipolar plate 10 shown there in precisely the same way as by the bipolar plate 10 of FIG. 1. In known manner, a fuel cell consisting of an anode (here the plate 16), a cathode (here the plate 18) and between them an electrolyte in the form of a membrane (here the membrane 42) exists between two adjacent bipolar plates 10, with the plates 16, 18 and the membrane lying between them forming the above-mentioned so-called MEA.

The shaping of the bipolar plate 10 of FIGS. 1 to 3 is produced here by an etching process and the plate is subsequently provided with a protective coating which consists in this example of three individual layers which will subsequently be described in more detail in connection with FIG. 5. It should be noted that this protective coating is first applied, after manufacturing the bipolar plate through an etching process, in a treatment chamber by a sputter process following the etching process, as will be later explained in more detail in connection with FIG. 8. As a result of the application in a treatment chamber by a sputtering process, this coating is present on all surface regions of the bipolar plate, i.e., not only the region of the channels 26 and 32, but rather also at the outer side edges and at the side edges of the supply and discharge openings 18 and 22.

FIG. 5 shows in a purely schematic representation, which is not drawn true to scale, a section of the bipolar plates of FIGS. 1 to 3, for example, in the edge region 12. The bipolar plate comprises a substrate 50 in the form of a sheet metal part which has a protective coating 52 at both sides. The protective coating comprises in this example three layers 54, 56 and 58. The first layer 54 is a coating of tin oxide with a thickness of 40 nm. The second layer 46 is a layer of silver with a thickness of 10 nm, whereas the third layer 48 likewise consists of tin oxide and has a thickness of 40 nm.

The silver of the second layer 56 forms a dopant for the two metal oxide layer 54 and 58 of tin oxide and causes them to have an adequate conductivity in order to be able to use the sheet metal part as a bipolar plate in a fuel cell or in an electrolyzer. The substrate 50 consists in this example of copper. It can, however, just as easily consist of aluminum, chrome-plated aluminum, stainless steel, chrome-plated stainless steel, titanium, titanium alloys or iron-containing compounds, and indeed both with and without metallic coating, with the metallic coating being able to consist of the elements tin, zinc, nickel, chromium or alloys of these materials.

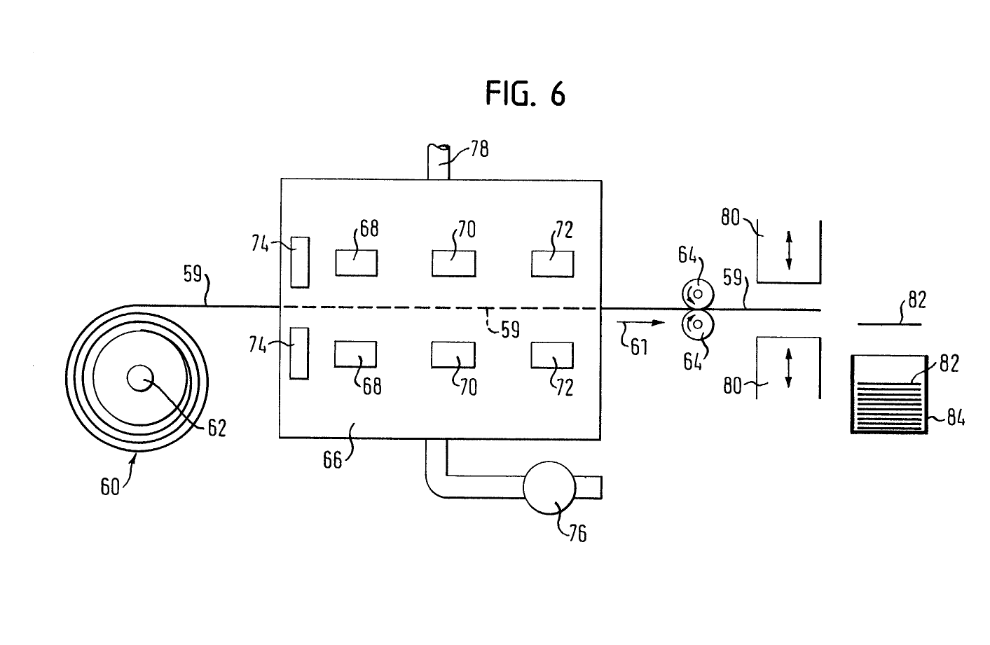

Various possibilities exist for the manufacture from sheet metal of bipolar plates or sheet metal products with a coating in accordance with the invention. One possibility is shown in FIG. 6. Here, a sheet metal strip 59 is present in the form of a large coil 60 which is rotatably mounted on an axle 62. The sheet metal strip is continually unwound from this coil 60, for example, by the draw rolls 64, and is drawn through a treatment chamber 66 sealed off relative to the environment. This treatment chamber is a plant known per se for carrying out PVD processes, with the chamber, for example, containing three respective sputter cathodes 68, 70 and 72 above and below the sheet metal strip 68. The sputter cathode 68 consists of tin oxide, the sputter cathode 70 of silver and the sputter cathode 72 again of tin oxide. All three sputter sources are operated simultaneously so that on movement of the sheet metal strip 60 through the treatment chamber 66 in the direction of travel 61, the first coating 54 is produced by the sputter cathodes 68, the second coating 56 by the sputter cathodes 70 and the third coating 58 by the sputter cathode 72. The treatment chamber can also have a plasma treatment unit or a unit for ion etching 74 arranged before the sputter cathodes 68, so that the sheet metal strip is freed of impurities prior to the actual coating. In usual manner, the treatment chamber is connected to a vacuum pump 76 and an inert gas, for example, argon, is introduced into the treatment chamber via a supply stub 78.

After leaving the treatment chamber, the sheet metal strip 59 is subdivided by a punching and/or embossing device into individual, for example, rectangular, sheet metal parts 82 which drop into a collecting container 84, or are carefully carried out of the region of the stamping procedure on a conveyor device, for example, in the form of a recirculating rubber belt. The sheet metal parts can be brought by a stamping or embossing device into a form similar to the form of FIGS. 1 to 3 and are then available as bipolar plates 10. Somewhat unfavorable in this connection, however, is that cut edges are provided where the protective coating is missing in the region of the supply discharge openings 20, 32 and 24, 34, respectively. This disadvantage can either simply be tolerated or can be overcome by a subsequent coating. The subsequent coating in these regions can be achieved by a special sputtering treatment or otherwise. In the region of the said openings, it is merely necessary to obtain adequate resistance to corrosion. In these regions, the conductivity of the coating is not important.

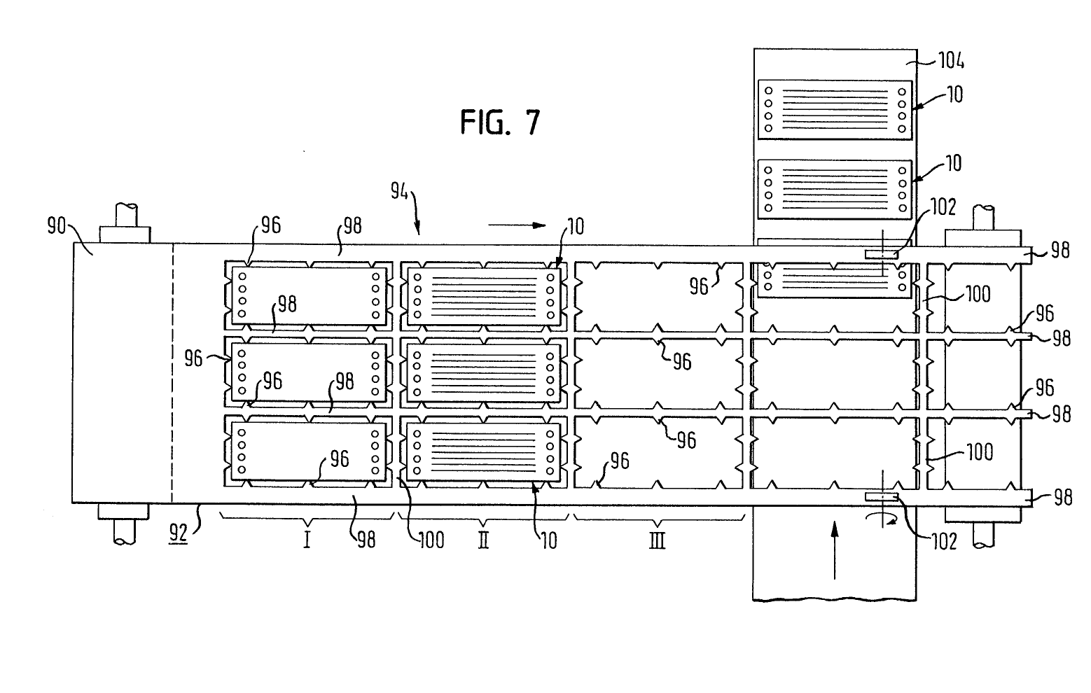

Another possibility of manufacturing the bipolar plates and also avoiding this subsequent treatment is shown in FIG. 7. A sheet metal strip 92 is also unwound in this case from a coil 90 and is drawn through progressive tooling 94, which here includes three working stations I, II and III. In the working station I, a stamping process is carried out in order to produce, in this example, three shaped sheet metal parts disposed alongside one another which each have in principle the same outer shape as the bipolar plates in FIGS. 1 to 3 and which are also provided with the supply and discharge openings 20, 32 and 24, 34, respectively. The individual, shaped sheet metal parts are, however, connected via small lugs 96 to one another and to the guide strips 98 and transverse webs 100 of the sheet metal strip 92, so that the strip can be transported from station to station through the progressive tooling. The transport of the sheet metal strip can, for example, take place, as shown here, by draw rolls 102 driven by a stepping motor which engage the marginal regions of the strip. In the second station II, a coining or embossing process is carried out in order to define, by shaping of the bipolar plates, regions which satisfy the functions of the flow passages 28 and 40 and of the connection passages 22, 26 and 38, respectively.

In the third station III, the shaped sheet metal parts are separated from one another and from the sheet metal strip 92 by shearing at the lugs 96 and then dropped after the progressive tooling, for example, onto a transverse belt 104, which brings them to a coating plant, for example, a coating plant of the kind shown in FIG. 8. The remainder of the strip can then either be coiled up, as shown at 106, or, as sometimes customary in progressive tooling, cut up into small parts which are then disposed off as scrap. A further possibility of coating lies in inserting a coating chamber such as 66 in FIG. 6 between the station III and the transverse belt, so that the coated bipolar plates drop in the finished state onto the transverse belt 104.

The individual plates 10 which are produced in the plant of FIG. 7 are now removed from the transverse belt and arranged in a treatment chamber 120 in accordance with FIG. 8 on a rotatable carrier 122, with only two such shaped sheet metal parts being shown in FIG. 8 for the sake of illustration. Within the chamber there are four sputter cathodes of which only three are shown, namely, the sputter cathode 124, 126 and 128, with the fourth cathode lying opposite to the cathode 126 and thus not being visible in the drawing of FIG. 8 because it is located in front of the plane of the drawing.

The reference numeral 132 points to a vacuum pump which is necessary to produce a vacuum in the treatment chamber 120, whereas the supply stub 134 serves for the supply of an inert gas, such as argon, or of a reactive gas, such as acetylene or oxygen, insofar as reactive sputtering is intended.

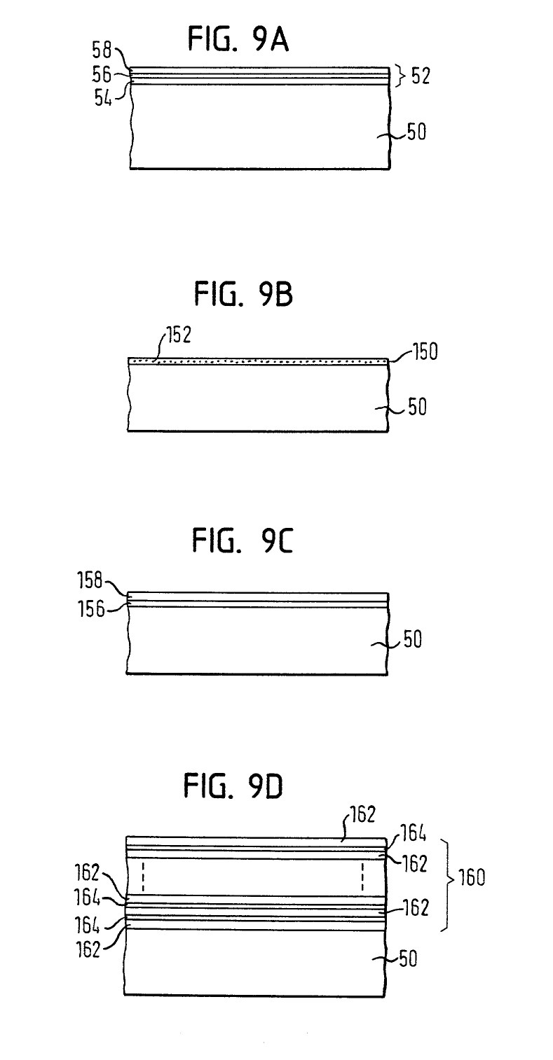

The cathodes 124 and 128 consist of tin oxide, whereas the cathode 126 and the cathode opposite to it consist of silver. All sputtering cathodes are formed as imbalanced magnetrons, so that in operation a vapor flux of tin, oxygen and silver ions and atoms arises and deposits onto the shaped sheet metal parts on all surfaces in the form of coatings of SnO2 and Ag, respectively. The shaped sheet metal parts are rotated with the rotary plate 122 about the axis 136 of the rotary plate and can also be rotated about further axes such as 140 and 142 by further turning devices which are carried by the rotary plate, so that all surfaces of the shaped sheet metal parts are exposed to the vapor fluxes from the individual sputter cathodes. The rotation of the rotary plate 122 during the coating process leads to a situation in which alternating layers of tin oxide and silver are formed on the formed sheet metal parts as shown in FIG. 9D. Should one desire a three-layer arrangement in accordance with FIG. 5, this can be produced in that the shaped sheet metal parts are first only exposed to the vapor of the two cathodes 124 and 128, then to the vapor flux of the cathode 126 and subsequently again only to the vapor flux of the two cathodes 124 and 128, i.e., the operating voltages for the individual cathodes which are operated as imbalanced magnetrons are switched on and off.

Another possibility of coating the shaped sheet metal parts lies in moving them on the transverse band through a treatment chamber in accordance with the treatment chamber 66 of the FIG. 6 embodiment.

Instead of producing the coating of tin oxide by wiring a cathode of tin oxide, one can take a cathode of pure tin and introduce oxygen into the atmosphere of the treatment chamber 120 via the supply stub 132. Under the conditions prevailing in the chamber, the oxygen then reacts with the tin ions and atoms to form tin oxide which is then deposited onto the surface of the shaped sheet metal parts. The process can be carried out in the manner which is described in EP-A-0 983 973.

FIGS. 9A-9D now show a series of possibilities for realizing the coating.

The reference numeral 50 indicates in each drawing the substrate which represents a sheet metal part and which can optionally already be structured or first be structured after the coating. When the structuring takes place after the coating, the development of the structuring should be such that the coating is not injured, be it by mechanical processing such as embossing or milling or by chemically supported processes such as etching processes or lithography. If the structuring is produced in such a way that a previously applied coating would be injured, then the structuring must first be carried out and the coating subsequently applied to the structured article.

In FIG. 9A the coating 52 consists of the same three layers 54, 56 and 58 as the coating of FIG. 5 with the difference that the protective coating is applied only to the one side of the substrate of the sheet metal part 60, for example when it is the terminal or outside plate of a single fuel cell which only needs to be protected at one side against corrosion.

In FIG. 9B the coating is present in the form of a thin (less than 10 nm) layer of tin oxide 150, which consists of a homogenous distribution of dopants in the form of one or more elements of the group aluminum, chromium, silver, boron, fluorine, antimony, chlorine, bromine, phosphorus, molybdenum and/or carbon. These dopants are indicated in the drawing by dots and by the reference numeral 152.

In FIG. 9C, 50 designates the same substrate, but here with a coating which consists of only two layers, namely a lower layer 156 of silver and an upper layer 158 of tin oxide.

Instead of silver, the layer 156 can comprise a further element of the group aluminum, chromium, silver, antimony and/or molybdenum. Since the layer 156 is a metallic layer, this layer can be deposited by a galvanic method instead of by using a PVD process in a treatment chamber. In this example, the layer 156 can, for example, have a thickness in the range between 1 and 500 nm and the layer 158 can have a thickness in the region between 1 and 500 nm.

FIG. 9D shows the substrate 50 with an alternating layer sequence 160 of layers of tin oxide 162 and of silver 164, with the uppermost layer consisting of tin oxide. A multilayer arrangement of this kind arises when a shaped sheet metal part is coated in a treatment chamber in accordance with FIG. 8, and indeed automatically as a result of the rotation of the rotary plate 122.

In the examples of FIGS. 9A-9D, the coatings are provided only on the upper side of the substrate 50. They could, however, additionally be realized in precisely the same manner on the lower side of the substrate.

Although in all previous examples the metal oxide is realized by tin oxide, it could also be zinc oxide or indium oxide, with oxides of alloys of the three named elements tin, zinc and indium (i.e., at least two of these elements) also entering into consideration. For the substrates 50, various sheet metal parts can be considered, namely sheet metal parts comprising aluminum, chrome-plated aluminum, copper, stainless steel, chrome-plated stainless steel, titanium, titanium alloys and iron-containing compounds, both with and without metallic coating, with the metallic coating comprising the elements tin, zinc, nickel, chrome or alloys of these materials.

When the coating consists of tin or zinc, it is conceivable that these could be treated in such a manner to produce the oxide layer directly on the article by reactions between oxygen ions and the coating.

1. A product for an electrochemical cell including a bipolar plate including a sheet metal product having a conductive and corrosion-resistant protective coating including a metal oxide on at least one side, with the metal oxide having a treatment which ensures conductivity.

2. A product in accordance with claim 1 wherein the treatment has been carried out in order to produce a crystal structure of the metal oxide coating which ensures conductivity.

3. A product in accordance with claim 1 wherein the treatment takes the forms of a galvanic coating consisting of one of the elements aluminum, chromium, silver, antimony or molybdenum applied directly below the metal oxide coating.

4. A product in accordance with claim 1 wherein the treatment is executed as a doping.

5. A product in accordance with claim 4 wherein the protective coating consists of at least one layer.

6. A product in accordance with claim 4 wherein the protective coating comprises an oxide of one of the following elements or alloys of these elements: tin, zinc, indium.

7. A product in accordance with claim 4 wherein the protective coating comprises a first layer of a metal oxide, a second layer of a dopant which ensures conductivity, and a third layer of a metal oxide.

8. A product in accordance with claim 1 wherein the protective coating comprises an alternating layer sequence of metal oxide and dopants which ensure conductivity

9. A product in accordance with claim 1 wherein the protective coating comprises at least two layers.

10. A product in accordance with claim 4 wherein the doping which ensures the conductivity comprises at least one element of the group aluminum, chromium, silver, boron, fluorine, antimony, chlorine, bromine, phosphorus, molybdenum and/or carbon.

11. A product in accordance with claim 1 wherein the protective coating comprises a protective coating deposited in a vacuum chamber.

12. A product in accordance with claim 1 wherein the protective coating has a thickness in the range between 1 monolayer and 1μ, preferably between approximately 1 nm and approximately 500 nm.

13. A product in accordance with claim 1 wherein the sheet metal comprises aluminum, chrome-plate aluminum, copper, stainless steel, chrome-plated stainless steel, titanium, titanium alloys and iron-containing compounds both with and without metallic coating, with the metallic coating including at least one of the elements tin, zinc, nickel, chromium or alloys of these materials.

14. A product in accordance with claim 1 wherein the sheet metal product has a thickness in the range from about 0.001 mm to about 5 mm.
